(19) United States
(12) Patent Application Publication
(10) Pub. No.: US 2007/0046285 A1
(43) Pub. Date: Mar. 1, 2007

(54) Sample observation method and observation device

(76) Inventor: Kenta Arima, Osaka (JP)

Correspondence Address: KUBOVCIK & KUBOVCIK, SUITE 710, 900 17TH STREET NW, WASHINGTON, DC, 20006, US

(21) Appl. No.: 11/509,077

(22) Filed: Aug. 24, 2006

Related U.S. Application Data
(60) Provisional application No. 60/711,696, filed on Aug. 29, 2005.

(51) Int. Cl. G01B 7/30

(52) U.S. Cl. 324/207.2

(57) ABSTRACT

A sample observation method and sample observation device of the present invention are for observing variation in surface potential of a sample due to variation in the Hall effect based on variation in an applied current or applied magnetic field to the sample, and allow the variation in the Hall effect generated in the sample to be locally observed. The Hall effect varies depending on internal structures, electronic states, etc. of the sample. The variation in surface potential due to variation in the Hall effect includes information on internal structures, electronic states, etc. of the sample.

This application claims priority of U.S. Provisional Application for Patent Ser. No. 60/711,696, filed Aug. 29, 2005, which is incorporated herein by reference.

### BACKGROUND OF THE INVENTION

1. Field of the Invention

The present invention relates to a sample observation method and observation device for observing microscopic internal structures, electronic states, etc. of samples including various materials.

2. Description of Related Art

For higher-performance next-generation electronic devices, it is essential to establish a technique that can measure/evaluate microscopic structures and electronic states inside electronic materials. For example, next-generation ultra-highly integrated semiconductor devices demand a technique for evaluating/controlling source-drain impurity profiles of Metal-Oxide-Semiconductor Field Effect Transistors (MOSFET) on the nanoscale. In order to realize further higher-performance solar cell devices and Thin Film Transistors (TFT) to be incorporated into liquid crystal displays, it is essential to develop a technique for observing polycrystalline silicon thin films, microcrystalline silicon thin films, or amorphous silicon thin films used therein with a nanoscale spatial resolution for local defects, impurity distribution, crystallinity, etc. inside the thin films, which determine the carrier mobility in the thin films.

Atomic structures of surfaces of electronic materials can be analyzed at the atomic level by using scanning probe microscopy. Scanning probe microscopy includes, for example, Scanning Tunneling Microscopy (STM) for detecting a tunnel current that flows between a sample surface and a probe, Atomic Force Microscopy (AFM) for detecting a force that acts between a sample surface and a probe, and Magnetic Force Microscopy (MFM).

R. M. Silver et al. have attempted visualization of pn junctions using Scanning Tunneling Spectroscopy (STS) with the use of a scanning tunnel microscope in “Delineation of pn junctions by scanning tunneling microscopy/spectroscopy in air and ultrahigh vacuum” (J. Vac. Sci. Technol. A13, 1705 (1995)). A. Kikukawa et al. have visualized pn junctions with high sensitivity using Kelvin force microscopy in “Silicon pn junction imaging and characterizations using sensitivity enhanced Kelvin probe force microscopy” (Appl. Phys. Lett. 66, 3510 (1995)). C. C. Williams et al. have attempted visualization of pn junctions by detecting depletion states on a semiconductor surface from variation in a displacement current between a probe and a sample surface, in other words, from measurement of capacitance, in “Lateral dopant profiling with 200 nm resolution by scanning capacitance microscopy” (Appl. Phys. Lett. 55, 1662 (1989)). Fukumura et al. have attempted measurement of the magnetic field intensity of a sample surface using a scanning Hall probe microscope including the Hall element in a probe in “Observation of magnetic domain in “anomalous” ferromagnets with scanning Hall probe microscope” (BUTSURI, the bulletin of the Physical Society of Japan 55, 521 (2000)). Richard Joseph Gambino et al. have observed the magnetic field intensity of a sample surface using an apparatus essentially including a scanning tunnel microscope in “Method for imaging magnetic structure or magnetic domain of sample and memory apparatus, wherein method thereof is applied” (JP 6-242130, A).

However, the electronic material observation methods using scanning probe microscopy as described above are a surface-sensitive approach in principle, and therefore can provide information only on surfaces or surface vicinities of the electronic materials. In many cases of semiconductor devices including integrated circuits and solar cells, structures, impurity distribution, and crystallinity inside electronic materials used therein crucially influence performance of the semiconductor devices.

The Hall effect is utilized in order to measure electronic states inside electronic materials, for example, the carrier type or carrier density. The Hall effect is a phenomenon in which when a magnetic field and current perpendicular to each other are applied to a sample, carriers in the sample experience the Lorentz force in a direction perpendicular to both the magnetic field and current to create a potential difference in the Lorentz force direction in the sample. The Van der Pauw method is widely known as a measuring method using the Hall effect. The Van der Pauw method applies, as shown in FIG. 13, a current in an in-plane direction (x-direction) of a sample 1, and also applies a magnetic field in the thickness direction (z-direction) of the sample 1. The potential difference due to the Hall effect is then measured between ends of the sample 1 in the direction (y-direction) perpendicular to the current application direction (x-direction) in the sample 1 surface. The mobility of the sample 1 can be further calculated by combining measurement of the potential difference due to the Hall effect with resistivity measurement. Hasumura discloses a scanning probe microscope having a function for applying an arbitrary horizontal magnetic field to a sample vicinity in “Scanning probe microscope” (JP 2003-161687, A), where only a magnetic field is applied but no current is applied to the sample, failing to generate the Hall effect in the sample.

However, the potential difference due to the Hall effect measured using the Van der Pauw method can provide only average information throughout the sample 1, but cannot detect local structures or electronic states inside the sample 1.

If the sample 1 is formed on an insulator, for example, in the case of a Silicon on Insulator (SOI), such a measuring method would be unable to measure the Hall voltage generated between the front surface and back surface (thin film/insulator substrate interface) of the sample 1 with a voltmeter.

H. Fujii et al. have observed surface potential distribution during application of a current to a silicon film formed on an insulator by scanning Maxwell-stress microscopy in “Characterization of electrical conduction in silicon nanowire by scanning Maxwell-stress microscopy” (Appl. Phys. Lett. 78, 2560 (2001)). However, there only a current is applied but no magnetic field is applied to the sample, failing to generate the Hall effect in the sample.

### SUMMARY OF THE INVENTION

An object of the present invention is to provide a sample observation method and sample observation device capable of providing information such as local internal structures and electronic states of the sample.

A sample observation method of the present invention detects variation in surface potential of a sample due to variation in the Hall effect based on variation in an applied current or applied magnetic field to the sample.

According to the above sample observation method of the present invention, the variation in surface potential (surface Hall potential) of the sample due to the Hall effect generated in the sample can be observed. The surface Hall potential is generated by the Lorentz force in the sample thickness direction acting on carriers in the sample to create an electric field (the Hall field) in the sample thickness direction. The surface Hall potential varies depending on variation in the Hall field and variation in thickness of the sample. Further, the Hall field varies depending on internal structures or electronic states of the sample. On the other hand, local surface potentials of the sample can be observed with existing devices, for example, Kelvin Probe Force microscopes. Therefore, information on local internal structures, electronic states, etc. of the sample can be obtained by observation of local surface Hall potentials of the sample.

Specifically, the variation in surface potential of the sample is detected between a first state where the Hall effect is generated in the sample and a second state where one of or both the current and magnetic field applied to the sample vary from those in the first state.

For example, between the first state and second state, the magnetic field may be varied with the current held constant, and, alternatively, the current may be varied with the magnetic field held constant. Further, the Hall effect may or may not occur in the second state of the sample. For example, in the second state of the sample, only the current may be applied but no magnetic field may be applied to the sample.

Further specifically, the method includes a first step of measuring surface potentials at the same measurement point in both the first state and second state; and a second step of calculating a difference between the surface potential in the first state and the surface potential in the second state. The magnetic field and current are applied in two directions perpendicular to each other in a plane parallel to a surface of the sample. The Hall effect is thereby generated in the sample.

Specifically, the current applied to the sample is held constant between the first state and second state, and only the current is applied to the sample in the second state.

Specifically, the variation in surface potential due to variation in the Hall effect is detected at a plurality of locations on a surface of the sample. The surface potential distribution along the surface of the sample can be thereby observed.

Specifically, the sample is formed covering a surface of an insulator.

Specifically, the surface potential of the sample is measured by the Kelvin method.

According to the Kelvin method, the surface potential can be measured even if the sample has a surface thereof covered with an insulator.

Still further specifically, the surface potential of the sample is measured by Kelvin Probe Force Microscopy.

Specifically, the current is applied between two adjacent points located on opposite sides of a measurement point for the surface potential.

Further specifically, the current is applied between opposite ends of the sample.

Specifically, after the first step, the sample is rotated in a plane parallel to the surface of the sample, and thereafter the first step is repeated at the same measurement point as in the previous first step.

A sample observation device of the present invention observes variation in surface potential of a sample due to variation in the Hall effect based on variation in an applied current or applied magnetic field to the sample.

Specifically, the device includes a stage having a sample holder for holding the sample; a current/magnetic field application unit capable of applying a magnetic field and current in two directions perpendicular to each other in a plane parallel to a flat portion of the stage, and capable of varying a magnitude of at least one of the current and magnetic field; and a probe for measuring a local surface potential of the sample.

Further specifically, the current/magnetic field application unit includes a current application unit and a magnetic field application unit.

Further specifically, the current application unit includes a pair of electrodes to be connected to a surface of the sample.

Further specifically, the pair of electrodes are made of a non-magnetic metal.

Further specifically, the pair of electrodes are conductive cantilevers for an atomic force microscope.

Preferably, the pair of electrodes can be positioned independently from each other in a plane parallel to the flat portion of the stage.

Further specifically, a pair of holding members for fixing the sample are arranged on opposite sides of the flat portion of the stage, and the pair of holding members serve as the pair of electrodes.

Specifically, the device includes a displacement mechanism for relatively displacing the probe in a plane parallel to the flat portion of the stage.

Specifically, the device includes an arithmetic unit for calculating the variation in surface potential due to variation in the Hall effect, using the surface potential measured by the probe as input data.

Further specifically, the arithmetic unit calculates the variation in surface potential due to variation in the Hall effect at a plurality of locations while the probe is being displaced in two directions along a surface of the sample.

Further specifically, the device includes a monitor unit for displaying the variation in surface potential calculated by the arithmetic unit as a two-dimensional distribution along the surface of the sample.

Specifically, the probe is a cantilever for a scanning probe microscope.

Further specifically, the scanning probe microscope includes an element for measuring the surface potential of the sample by Kelvin Probe Force Microscopy.

Further specifically, an AC power source and a DC bias necessary for Kelvin Probe Force Microscopy are connected between the probe and a ground, or between a power source of the current and a ground.

Further specifically, the scanning probe microscope includes an element for measuring the surface potential of the sample by the Kelvin method.

Specifically, the magnetic field application unit is constituted of a permanent magnet, and includes a magnet drive unit for varying a distance between the permanent magnet and the flat portion of the stage.

Further specifically, the magnetic field application device includes an electric magnet, a Helmholtz coil, or a superconducting magnet.

Specifically, the stage is supported rotatably in a plane parallel to the flat portion, and coupled to a rotational drive mechanism.

As described above, according to the sample observation method and sample observation device of the present invention, local internal structures and electronic states of a sample can be observed.

### BRIEF DESCRIPTION OF THE DRAWINGS

FIG. 1 is a perspective view schematically showing an observation device of the present invention;

FIG. 2 is a perspective view of the observation device shown in FIG. 1 in another state;

FIG. 3 is a perspective view of the observation device shown in FIG. 1 in still another state;

FIG. 4 is a perspective view of another observation device of the present invention;

FIG. 5 illustrates an image picture of a surface Hall potential distribution;

FIG. 6 is a perspective view of a sample for explaining the Hall effect;

FIG. 7 is a graph showing the surface Hall potential of a p-type silicon wafer;

FIG. 8 is a graph showing the surface Hall potential of an n-type silicon wafer;

FIG. 9 is a graph showing the surface Hall potential of a p-type silicon film formed on an insulator;

FIG. 10 is a perspective view of a sample having a back surface partly removed therefrom;

FIG. 11 is a plan view of the sample having the back surface partly removed therefrom;

FIG. 12 is a graph showing surface Hall potentials of the sample having the back surface partly removed therefrom; and

FIG. 13 is a plan view of a sample for explaining a conventional measuring method for the Hall effect.

### DETAILED DESCRIPTION OF THE INVENTION

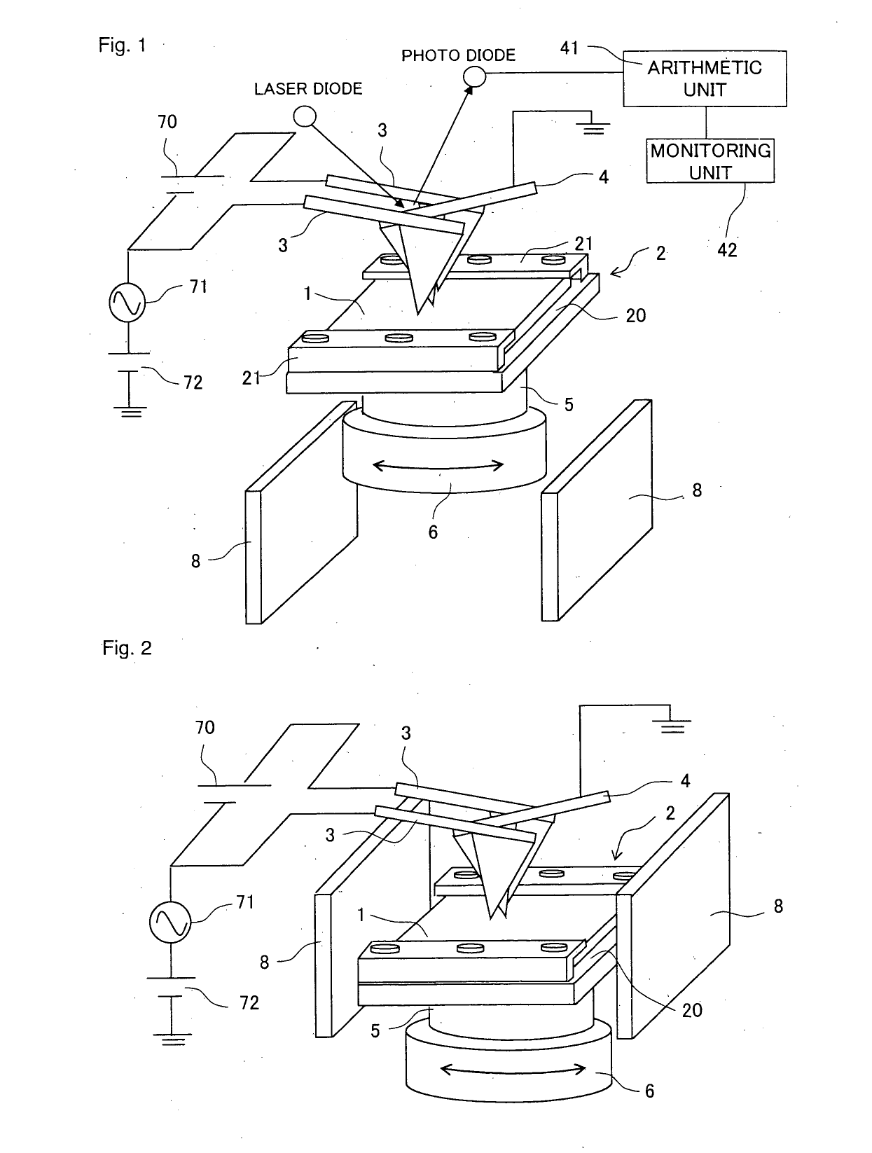

Embodiments of the present invention will be specifically described below with reference to the drawings. FIG. 1 shows a first embodiment of a sample observation device of the present invention. The observation device of the first embodiment includes a scanning probe microscope for measuring a local surface potential of a sample 1 by Kelvin Probe Force Microscopy, and a current/magnetic field application unit for applying a current and magnetic field to the sample 1.

The scanning probe microscope includes a stage 2 for fixing the sample 1 and a conductive cantilever 4 as a probe for measuring the surface potential. The stage 2 is made of an insulating material such as Macor, and includes a pair of holding plates 21, 21 arranged at opposite ends of a flat portion 20 for holding the sample 1. Opposite ends of the sample 1 are held between the flat portion 20 and the pair of holding plates 21, 21 to fix the sample 1 on the stage 2. The stage 2 is placed on a rotary stage 6 via an xyz-axis piezo driver 5. The stage 2 can rotate together with the rotary stage 6 and xyz-axis piezo driver 5 in a plane parallel to the flat portion 20 of the stage 2. The cantilever 4 for serving as a probe is arranged above the flat portion 20 of the stage 2. The cantilever 4 is grounded. The cantilever 4 can be relatively displaced in a plane parallel to the flat portion 20 of the stage 2 by moving the stage 2 with the xyz-axis piezo driver 5.

On the other hand, the current/magnetic field application unit for applying a current and magnetic field to the sample 1 includes a current application unit and a magnetic field application unit. The current application unit includes a pair of electrodes 3, 3 to be connected to a surface of the sample 1. The pair of electrodes 3, 3 are made of a non-magnetic metal such as titanium or aluminum. Therefore, the sample 1 will not experience any magnetic force from the pair of electrodes 3, 3. The pair of electrodes 3, 3 are arranged above the flat portion 20 of the stage 2, and can move independently from each other in a plane parallel to the flat portion 20 of the stage 2. Further, the pair of electrodes 3, 3 are conductive cantilevers for Atomic Force Microscopy (AFM). Therefore, an atomic force microscope with the pair of electrodes 3, 3 serving as a probe enables one to observe the surface of the sample 1, and allows one to move the pair of electrodes 3, 3 while observing the surface of the sample 1.

The pair of electrodes 3, 3 are connected to a current source 70. The current source 70 has a reference potential side connected to a ground. An AC power source 71 and a DC bias 72 necessary for Kelvin Probe Force Microscopy are connected between the current source 70 and the ground. The current source 70 can use both a constant current mode and a constant voltage mode. The AC power source 71 and DC bias 72 may be connected between the cantilever 4 as a probe and a ground.

On the other hand, the magnetic field application unit includes a pair of permanent magnets 8, 8. The pair of permanent magnets 8, 8 are oppositely arranged via the stage 2. A magnetic field parallel to the flat portion 20 of the stage 2 is formed between the pair of permanent magnets 8, 8. The magnetic field formed between the pair of permanent magnets 8, 8 typically has an intensity of 0.1-0.7 T. The pair of permanent magnets 8, 8 are held by a displacement mechanism (not shown) while maintaining a distance between each other, and movably in a direction perpendicular to plane directions of the flat portion 20 of the stage 2. When the pair of permanent magnets 8, 8 are oppositely arranged via the flat portion 20 of the stage 2, the magnetic field is applied to the sample 1. On the other hand, when the pair of permanent magnets 8, 8 are arranged apart from the flat portion 20 of the stage 2, for example, when arranged above or below the flat portion 20, no magnetic field is applied to the sample 1.

Using such an observation device, the variation in surface potential of the sample 1 (surface Hall potential) is observed between with and without the Hall effect occurring in the sample 1.

Next, a method for observing the surface Hall potential of the sample 1 with the above device will be described. First, the sample 1 is placed on the flat portion 20 of the stage 2, and fixed by having opposite ends of the sample 1 sandwiched between the flat portion 20 and the pair of holding plates 21, 21. The surface potential of the sample 1 is then measured without the Hall effect occurring in the sample 1. At this time, the pair of permanent magnets 8, 8 are arranged below the flat portion 20 of the stage 2, so that the magnetic field formed between the pair of permanent magnets 8, 8 is not applied to the sample 1. The pair of electrodes 3, 3 are then moved while being used to observe the sample 1 surface with the atomic force microscope, and connected to desired positions on the sample 1 surface. At this time, the pair of electrodes 3, 3 are arranged at adjacent positions along a direction perpendicular to the direction of the magnetic field formed between the pair of permanent magnets 8, 8, and the cantilever 4 for serving as a probe is arranged at an approximate center between the pair of electrodes 3, 3.

Thereafter, a voltage is applied between the pair of electrodes 3, 3 by the current source 70 to apply a current in an in-plane direction of the surface of the sample 1. Such a pair of electrodes 3, 3 allow a current with a high current density to be applied to only a microscopic area of the sample 1 between the pair of electrodes 3, 3. As described later, the surface Hall potential of the sample 1 can be amplified and detected with high sensitivity by applying a current with a high current density to the sample 1. On the other hand, if a current with a high current density is applied to the whole sample 1, the sample 1 could be high in temperature and destroyed due to resistance heating. The distance between the pair of electrodes 3, 3 is determined depending on the thickness of the sample 1. When the sample 1 has a thickness of 0.1 μm to 100 μm, the pair of electrodes 3, 3 are set to have a distance of 0.1 μm to 1.0 mm.

Next, the DC bias 72 is controlled to measure the surface potential of the sample 1 by Kelvin Probe Force Microscopy. According to Kelvin Probe Force Microscopy, the surface potential of the sample 1 can be measured with a nanoscale, high spatial resolution.

Further, the cantilever 4 for serving as a probe is moved to another position on the sample 1 surface together with the pair of electrodes 3, 3 to measure the surface potential at a plurality of locations on the sample 1 surface. In this way, the surface potential distribution can be observed without the Hall effect occurring in the sample 1.

Next, the surface potential of the sample 1 is measured with the Hall effect occurring in the sample 1. At this time, the pair of permanent magnets 8, 8 are moved so as to be oppositely positioned via the flat portion 20 of the stage 2, while the current source 70 maintains the voltage applied to the pair of electrodes 3, 3. In this state, the magnetic field formed between the pair of permanent magnets 8, 8 is applied in a in-plane direction of the surface of the sample 1 fixed to the stage 2, so that the magnetic field applied to the sample 1 is perpendicular to the current in the surface of the sample 1. In this way, the magnetic field and current are applied in two directions perpendicular to each other in the surface of the sample 1 to thereby generate the Hall effect in the sample 1. This causes the Lorentz force to act on carriers in the sample 1 in the thickness direction of the sample 1 to create an electric field (the Hall field) in the thickness direction of the sample 1. The surface potential of the sample 1 is then measured at a plurality of measurement points on the sample 1 surface with the Hall effect occurring in the sample 1. The locations of the plurality of measurement points on the sample 1 with the Hall effect are the same as the locations of the plurality of measurement points on the sample 1 without the Hall effect. More minute internal structures and electronic states of the sample 1 can be observed with high sensitivity by increasing the magnetic field intensity applied to the sample 1. Besides the pair of permanent magnets 8, 8, electric magnets, Helmholtz coils, or superconducting magnets may be used in order to form a magnetic field to be applied to the sample 1. Electric magnets, Helmholtz coils, or superconducting magnets will not form a magnetic field unless these are powered. When powered, electric magnets, Helmholtz coils, and superconducting magnets can form a magnetic field with a magnitude of 2 T, 0.1 T, and 10 T, respectively, at a maximum.

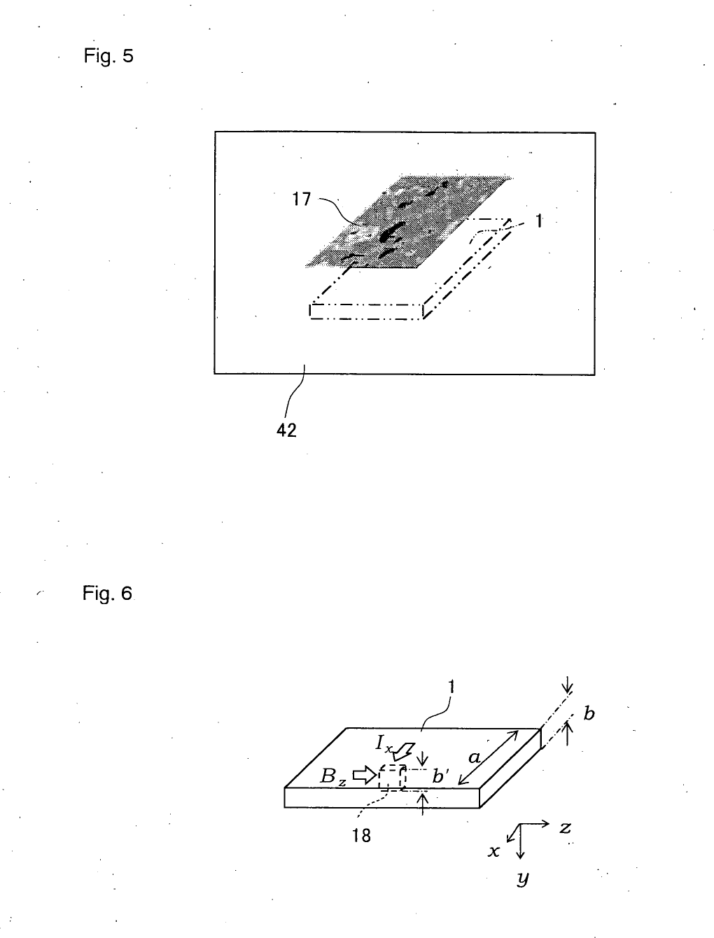

After the surface potential of the sample 1 is measured with the Hall effect occurring in the sample 1, an arithmetic unit 41 calculates a difference in each of the measurement points between the surface potential of the sample 1 without the Hall effect and the surface potential of the sample 1 with the Hall effect, which is defined as a difference between the surface potentials due to the Hall effect generated in the sample 1 (the surface Hall potential). Based on data of surface Hall potentials in the measurement points calculated by the arithmetic unit 41, two-dimensional distribution of the surface Hall potentials along the surface of the sample 1 (the surface Hall potential distribution) is then displayed and visualized by a monitoring unit 42 as an image picture 17 as shown in FIG. 5. It is not always necessary to visualize the surface Hall potential distribution of the sample 1. The above observation method observes the surface Hall potential at a plurality of measurement points on the sample 1, but the surface Hall potential of the sample 1 may be observed at only one measurement point.

The surface Hall potential of the sample 1 as described varies depending on variation in the Hall effect generated in the sample 1 and variation in thickness of the sample 1. The Hall effect generated inside the sample 1 varies depending on the carrier mobility of the sample 1. Therefore, observation of the surface Hall potential can provide information on the carrier mobility of the sample 1, thickness of the sample 1, etc.

Further, the carrier mobility in the sample 1 varies due to presence of defects such as crystalline disturbance in the sample 1, or holes, mixed impurities, or dangling bonds inside the sample 1. Therefore, presence of defects in the sample 1 also can be detected from the surface Hall potential. Thus, internal structures, electronic states, etc. of the sample 1 can be observed with a nanoscale, high spatial resolution with ease and high sensitivity without destroying the sample 1. Because the surface Hall potential can provide information on the thickness of the sample 1, thickness distribution of a silicon film formed on an insulator (an SOI layer) can be observed with a nanoscale, high spatial resolution.

It is useful for higher-performance solar cell devices or thin film transistors, for example, to provide information on the carrier mobility in the sample 1. In addition, it is useful in cleanliness evaluation and film quality evaluation in a semiconductor thin film formation process, for example, to detect presence of impurities of the sample 1. It is useful for higher-performance power generation layers of solar cell devices, for example, to detect variation in local crystalline distribution of the sample 1.

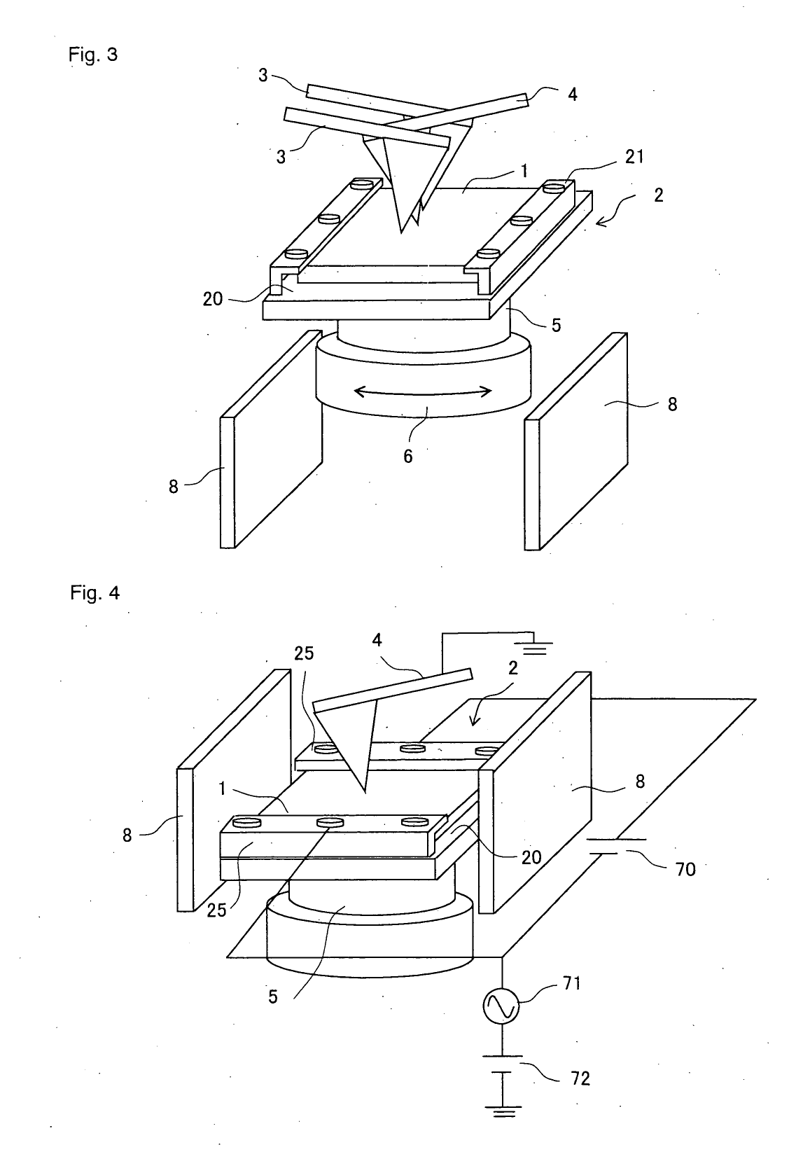

Further, if the sample 1 has anisotropy, the surface Hall potential of the sample 1 exhibits dependence on the magnetic field application direction and current application direction. Observation of the direction dependence of the surface Hall potential can provide, for example, information on direction-dependent steepness of pn junctions. In order to observe such direction dependence of the surface Hall potential, first, the sample 1 is fixed on the stage 2 such that a central portion of the sample 1 is positioned on a rotation axis of the rotary stage 6, as shown in FIG. 1 and FIG. 2. The surface Hall potential of the central portion of the sample 1 is then observed. Next, as shown in FIG. 3, the rotary stage 6 is rotated to rotate the sample 1 in the surface of the sample 1. FIG. 1 and FIG. 3 show an example where the sample 1 rotates by 90 degrees. The pair of electrodes 3, 3 and pair of permanent magnets 8, 8 do not move at this time, and therefore the magnetic field and current applied to the sample 1 are always perpendicular to each other in the surface of the sample 1 regardless of the rotation of the sample 1. After the sample 1 is rotated, the surface Hall potential of the central portion of the sample 1 is observed again. Thereafter compared are the surface Hall potentials before and after the rotation of the sample 1, in other words, those in two states with different magnetic field directions and current directions to the sample 1.

FIG. 4 shows a second embodiment of the observation device of the present invention. An observation device of the second embodiment has the stage 2 provided with a pair of holding plates 25, 25, which are made of a non-magnetic metal such as titanium or aluminum. The pair of holding plates 25, 25 are used also as a pair of electrodes for applying a current to the sample 1. The pair of holding plates 25, 25 are arranged along a direction perpendicular to a direction of a magnetic field formed between the pair of permanent magnets 8, 8. Therefore, a current that flows between the pair of holding plates 25, 25 is perpendicular to the magnetic field in the surface of the sample 1. Such a pair of holding plates 25, 25 are connected to the current source 70 as the pair of electrodes 3, 3 are in the first embodiment shown in FIG. 1. The current is applied throughout the sample 1 when the surface potential of the sample is measured with the observation device of the second embodiment.

The above embodiment measures the surface potential of the sample 1 by Kelvin Probe Force Microscopy, but the Kelvin method can also measure the surface potential of the sample 1. The Kelvin method also allows the surface potential of the sample 1 to be measured with a micrometer-scale, high spatial resolution. Even if the surface of the sample 1 is covered with an insulating film, the Kelvin method, which can detect a displacement current that flows between the probe and sample 1, could measure the surface potential of the sample 1 that exists in the interface between the insulating film and sample 1.

In the above embodiment, a scanning probe microscope is used in order to measure local surface potentials of the sample 1, but local surface potentials of the sample 1 may be measured with other approaches without using a scanning probe microscope.

Next, a description will be given of provision of information on a local carrier mobility etc. of the sample 1 by observation of the surface Hall potential. As shown in FIG. 6, the length direction of the rectangular sample 1 is defined as the x-direction, the width direction as the z-direction, and the thickness direction as the y-direction. When a current Iₓ is applied in the x-direction, and a magnetic field B_{z} is applied in the z-direction, the Hall effect occurs in the sample 1, so that carriers inside the sample 1 experience the Lorentz force in the y-direction. When an elementary charge of a carrier is represented as q, a y-direction component of an electric field (the Hall field) inside the sample 1 as E_{y}, and an x-direction component and a z-direction component of the drift velocity of the carrier as νₓ, ν_{z}, respectively, a y-direction force F_{y} that acts on the carrier is expressed as
F_{y}=±q {E_{y}+[ν×B]_{y}}=±q {E_{y}+(ν_{z}Bₓ−νₓB_{z})} (1).
Note that ±q in the above formula 1 is a positive value, i.e. +q, when the carrier is a positive hole, and is a negative value, i.e. −q, when the carrier is an electron. In a steady state, the y-direction force F_{y} that acts on the carrier is balanced, so that this is expressed as F_{y}=0. Because the magnetic field B_{z} only has a z-direction component without an x-direction component, the above formula 1 is expressed as
F_{y}=±q {E_{y}−νₓB_{z}}=0 (2).
Therefore, the y-direction component E_{y} of the electric field is expressed as
E_{y}=νₓB_{z} (3).
With a microscopic element 18 in the sample 1, when the y-direction dimension of the microscopic element 18 is represented as b′, the Hall voltage V_{y} generated across the upper and lower surfaces of the microscopic element 18 (in the y-direction) by the Hall effect generated in the sample 1 is expressed as
V_{y}=b′E_{y}=b′νₓB_{z} (4).

When the carrier mobility in the microscopic element 18 is represented as μ, and an x-direction component of an electric field in the microscopic element 18 as Eₓ, the x-direction component νₓ of the drift velocity of the carrier is expressed as
νₓ=μEₓ (5).
Therefore, the Hall voltage V_{y} generated in the thickness direction (y-direction) of the microscopic element 18 is expressed as
V_{y}=b′μEₓB_{z} (6).
The above formula 6 reveals that when the electric field Eₓ and magnetic field B_{z} are held constant anywhere inside the sample 1, the Hall voltage V_{y} generated across the upper and lower surfaces of the microscopic element 18 (in the y-direction) is proportional to the thickness b′ of the microscopic element 18 and the mobility μ of the carrier flowing in the microscopic element 18.

The Hall voltage V_{y} as described is in a proportional relationship with the surface Hall potential Φ_{SHP}. That is to say, when the proportional constant is represented as k, the surface Hall potential Φ_{SHP} can be expressed as
Φ_{SHP}=kV_{y} (7).

The above formula 6 and the above formula 7 reveal that the surface Hall potential Φ_{SHP} in each measurement point on the sample 1 is proportional to the sample thickness b′ of the microscopic area 18 and carrier mobility μ in each measurement point.

On the other hand, when the carrier density inside the sample 1 is represented as n, the current density Jₓ of the current flowing through the sample 1 is expressed as
Jₓ=nqμEₓ (8).

Further, in the case where the thickness of the sample 1 is uniform across the whole area of the sample 1, and the current density Jₓ is uniform across the whole area of the sample 1, when the width dimension (x-direction dimension) and thickness dimension (y-direction dimension) of the entire sample 1 are represented as a, b, respectively, the current density Jₓ is expressed as
Jₓ=Iₓ/ab (9).
With reference to the above formula 6, formula 8 and formula 9, the Hall voltage V_{y} generated in the thickness direction (y-direction) of the sample 1 is expressed as
V_{y}=IₓB_{z}/nqa (10).
The above formula 10 reveals that if the thickness of the sample 1 is uniform across the whole area of the sample 1, and the current density is uniform across the whole area of the sample 1, the surface Hall potential Φ_{SHP}, which is proportional to the Hall voltage V_{y}, is proportional to the applied current Iₓ. In addition, the above formula 7 through formula 10 reveal that the surface Hall potential Φ_{SHP} can be observed with high sensitivity by increase in the current density Jₓ in a measurement point of the surface Hall potential Φ_{SHP}.

Shown below is a result of observation of the surface Hall potential of various samples 1 by the Kelvin method using the observation device of the second embodiment. The magnetic field formed between the pair of permanent magnets 8, 8 has a magnitude of 0.7 T.

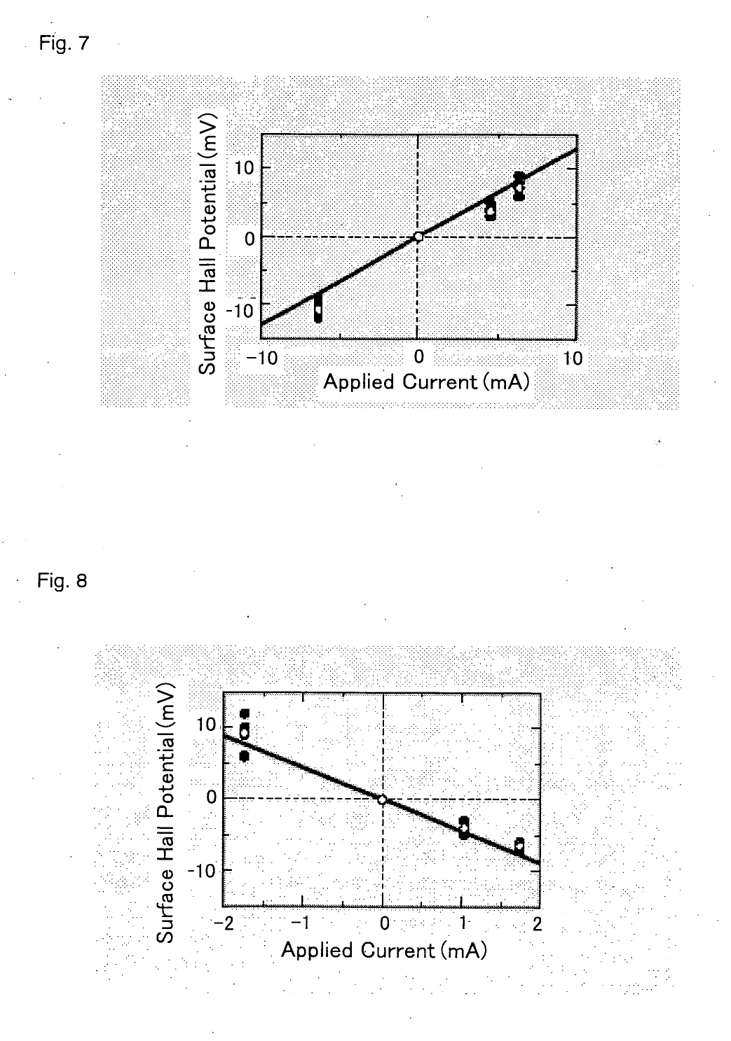

FIG. 7 is a graph showing a relationship between the surface Hall potential and applied current of a p-type silicon wafer. The surface Hall potential was observed at only one point on the p-type silicon wafer surface. The graph of FIG. 7 reveals that the surface Hall potential is proportional to the applied current. The above formula 7 and formula 10 correspond to the fact that the surface Hall potential is proportional to the applied current, as described. Observation of the surface Hall potential allows prediction of the Hall voltage in measurement points where the surface Hall potential has been observed.

FIG. 8 is a graph showing a relationship between the surface Hall potential and applied current of an n-type silicon wafer. The surface Hall potential was observed at only one point on the n-type silicon wafer surface. In the n-type silicon wafer, as shown in the graph of FIG. 8, the negative surface Hall potential is observed due to the positive applied current, and the positive surface Hall potential is observed due to the negative applied current. On the other hand, in the p-type silicon wafer, as shown in the graph of FIG. 7, the positive surface Hall potential is observed due to the positive applied current, and the negative surface Hall potential is observed due to the negative applied current. This result reveals that positivity and negativity of the surface Hall potential are reversed depending on whether carriers of the sample 1 are electrons or positive holes. The fact that positivity and negativity of the surface Hall potential are reversed depending on the carrier type corresponds to the fact that positivity and negativity of the drift velocity νₓ of the carrier expressed in the above formula 4 and positivity and negativity of the mobility μ of the carrier expressed in the above formula 5 are reversed depending on the carrier type. Thus, pn junctions of the sample 1 can be visualized with a nanoscale, high spatial resolution based on the surface Hall potential distribution of the sample 1. Such visualization of pn junctions is useful in a production process for high-performance nano-integrated circuits.

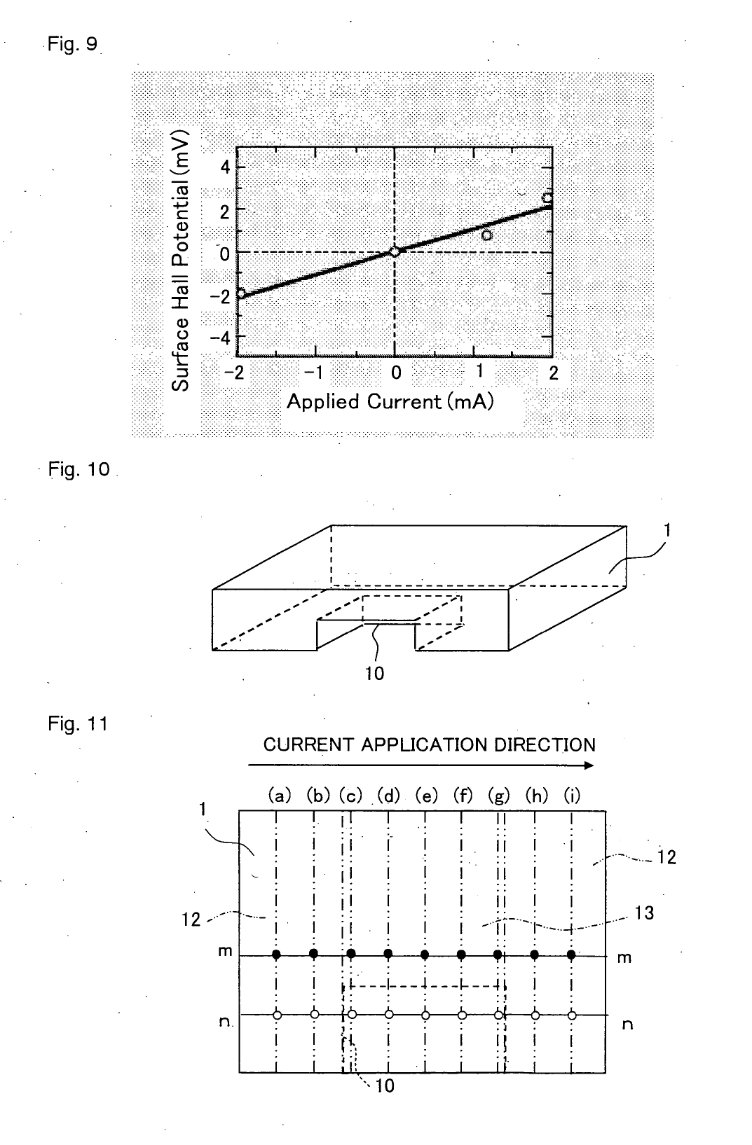

FIG. 9 is a graph showing a relationship between the surface Hall potential and applied current of a p-type silicon thin film formed on an insulating film (Silicon on Insulator: SOI). The insulating film is a buried oxide film, while the silicon thin film has a thickness of 100 μm. The surface Hall potential was observed at only one point on a surface of the p-type silicon thin film. As understood from the graph of FIG. 9, the surface Hall potential increases along with increase in the applied current also in the p-type silicon thin film formed on the insulating film, as in the relationship between the surface Hall potential and applied current of the p-type silicon wafer shown in the graph of FIG. 7. The positive surface Hall potential is observed due to the positive applied current, and the negative surface Hall potential is observed due to the negative applied current. This result shows that the surface Hall potential can be observed even if the sample 1 is formed on an insulator.

Next, a description will be given of variation in the surface Hall potential depending on the current density in the sample 1. As shown in FIG. 10, a sample 1 of an n-type silicon wafer has a back surface partly removed therefrom by machining. The surface Hall potential of the sample 1 was measured by the Kelvin method using the observation device of the second embodiment. The magnetic field formed between the pair of permanent magnets 8, 8 has a magnitude of 0.7 T. The removed portion 10 of the sample 1 is formed extending from a part of one end surface of the sample 1 along the current application direction toward the opposite surface. The sample 1 has a thickness of 625 μm, and the removed portion 10 has a depth of 400 μm. The sample 1 has a dimension of 10 mm along the current application direction, and the removed portion 10 has a dimension of 4.0 mm along the current application direction. As shown in FIG. 11, the sample 1 has an area 13 including the removed portion 10 and areas 12, 12 not including the removed portion 10, which exist side by side along the current application direction. The area 13 including the removed portion 10 has a cross section perpendicular to the current direction of the sample 1 smaller than that of the areas 12, 12 not including the removed portion 10. The current flowing in the sample 1 has an increased current density as the sample 1 has a smaller cross section perpendicular to the current direction. As shown by the above formula 8, the increase in the current density Jₓ increases the x-direction component Eₓ of the electric field. As shown by the above formula 6, the increase in the x-direction component Eₓ of the electric field in turn increases the Hall voltage V_{y}. As shown by the above formula 7, the increase in the Hall voltage V_{y} increases the surface Hall potential Φ_{SHP}. On the other hand, the sample 1 has a thinner thickness in the removed portion 10. As shown by the formula 6, the Hall voltage V_{y} decreases as the thickness b′ of the sample 1 is thinner. As shown by the above formula 7, the decrease in the Hall voltage V_{y} decreases the surface Hall potential Φ_{SHP}.

As shown in FIG. 11, measurement points for surface potentials of the sample 1 are arranged on a line n extending parallel to the current application direction and passing over the removed portion 10, and on a line m extending parallel to the current application direction without passing over the removed portion 10. On the line n passing over the removed portion 10, measurement points c, d, e, f, g are arranged above the removed portion 10, and measurement points a, b, h, i are positioned off the upper part of the removed portion 10. On the line m not passing over the removed portion, measurement points c, d, e, f, g are arranged in the area 13 including the removed portion 10, and measurement points a, b, h, i are arranged in the areas 12, 12 not including the removed portion 10.

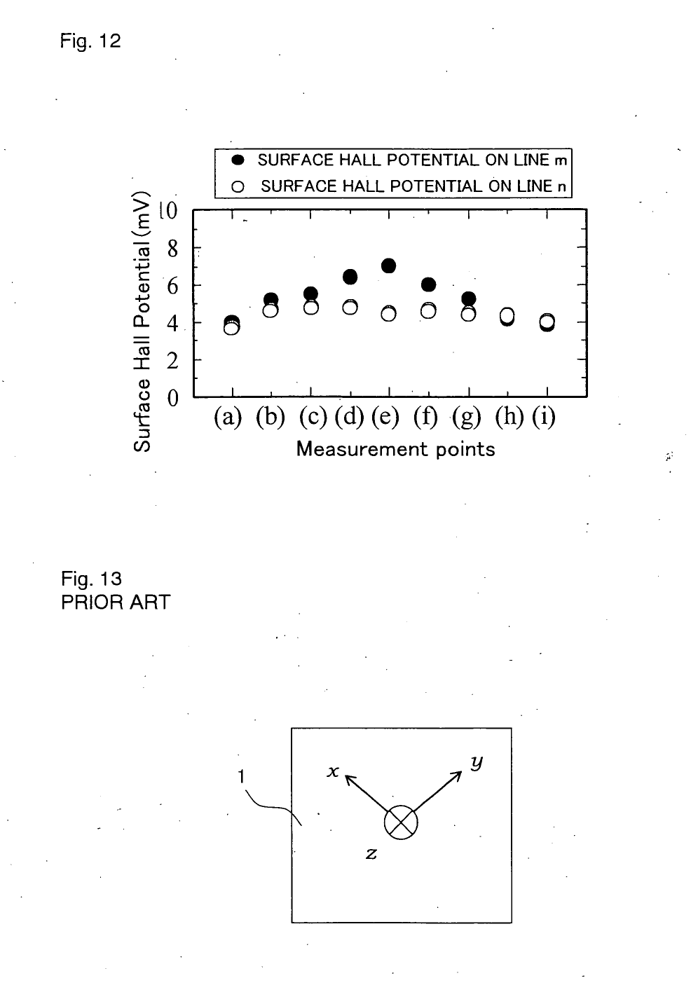

FIG. 12 is a graph showing the surface Hall potentials in the respective measurement points. As understood from the graph, on the line m not passing over the removed portion 10, the measurement points c, d, e, f arranged in the area 13 including the removed portion 10 have the increased surface Hall potentials compared with the surface Hall potentials of the measurement points a, b, h, i arranged in the areas 12, 12 not including the removed portion 10. This is probably because the area 13 including the removed portion 10 has an increased current density compared with the current density of the areas 12, 12 not including the removed portion 10. On the other hand, on the line n passing over the removed portion 10, the measurement points c, d, e, f arranged above the removed portion 10 have the comparable surface Hall potentials compared with the surface Hall potentials of the measurement points a, b, h, i positioned off the upper part of the removed portion 10. This is probably because although the current density above the removed portion 10 increases compared with the current density of the positions off the removed portion 10, the sample 1 has a thinner thickness above the removed portion 10 than the thickness of the sample 1 off the removed portion 10, so that the increase and decrease of the surface Hall potential are balanced out. The result as described indicates a possibility that current distribution in the sample 1 can be visualized based on the surface Hall potential distribution.

The present invention is not limited to the foregoing embodiments but can be modified variously by one skilled in the art without departing from the spirit of the invention as set forth in the appended claims. For example, the surface potential of the sample 1 may be measured with the Hall effect occurring in the sample 1, and thereafter the surface potential of the sample 1 may be measured without the Hall effect occurring in the sample 1, while in the above observation method, the surface potential of the sample 1 is measured without the Hall effect occurring in the sample 1, and thereafter the surface potential of the sample 1 is measured with the Hall effect occurring in the sample 1. In order to observe the surface Hall potential, it is necessary to measure respective surface potentials of the sample 1 while varying the magnitude of the Hall effect generated in the sample 1. The magnetic field may be always applied to the sample 1 with various magnitudes of the magnetic field. Alternatively, the current magnitude may be varied in order to vary the magnitude of the Hall effect.

It is possible to observe, not only the surface Hall potential of silicon wafers and silicon films formed on insulators, but also the surface Hall potential of other samples such as gallium arsenic wafers used in the semiconductor industry or environment/energy industry, polycrystalline silicon thin films used for thin film transistors, noncrystalline and microcrystalline silicon thin films used for power generation layers of solar cell devices, or conductive organic thin films, to observe internal structures and electronic states of these at the atomic level. The sample may be inorganic and organic semiconductor thin films formed on insulator substrates or insulator thin films.

What is claimed is:

1. A sample observation method for detecting variation in surface potential of a sample due to variation in the Hall effect based on variation in an applied current or applied magnetic field to the sample.

2. The sample observation method according to claim 1, wherein the variation in surface potential of the sample is detected between a first state where the Hall effect is generated in the sample and a second state where one of or both the current and magnetic field applied to the sample vary from those in the first state.

3. The sample observation method according to claim 2, wherein the method comprises:
a first step of measuring surface potentials at the same measurement point in both the first state and second state; and
a second step of calculating a difference between the surface potential in the first state and the surface potential in the second state.

4. The sample observation method according to claim 1, wherein the magnetic field and current are applied in two directions perpendicular to each other in a plane parallel to a surface of the sample to thereby generate the Hall effect in the sample.

5. The sample observation method according to claim 2, wherein the current applied to the sample is held constant between the first state and second state.

6. The sample observation method according to claim 5, wherein only the current is applied to the sample in the second state.

7. The sample observation method according to claim 1, wherein the variation in surface potential due to variation in the Hall effect is detected at a plurality of locations on a surface of the sample.

8. The sample observation method according to claim 1, wherein the sample is formed covering a surface of an insulator.

9. The sample observation method according to claim 1, wherein the surface potential of the sample is measured by the Kelvin method.

10. The sample observation method according to claim 9, wherein the sample has a surface thereof covered with an insulator.

11. The sample observation method according to claim 1, wherein the surface potential of the sample is measured by Kelvin Probe Force Microscopy.

12. The sample observation method according to claim 1, wherein the current is applied between two adjacent points located on opposite sides of a measurement point for the surface potential.

13. The sample observation method according to claim 1, wherein the current is applied between opposite ends of the sample.

14. The sample observation method according to claim 3, wherein after the first step, the sample is rotated in a plane parallel to the surface of the sample, and thereafter the first step is repeated at the same measurement point as in the previous first step.

15. A sample observation device for observing variation in surface potential of a sample due to variation in the Hall effect based on variation in an applied current or applied magnetic field to the sample.

16. The sample observation device according to claim 15, wherein the device comprises a stage having a sample holder for holding the sample; a current/magnetic field application unit capable of applying a magnetic field and current in two directions perpendicular to each other in a plane parallel to a flat portion of the stage, and capable of varying a magnitude of at least one of the current and magnetic field; and a probe for measuring a local surface potential of the sample.

17. The sample observation device according to claim 16, wherein the current/magnetic field application unit comprises a current application unit and a magnetic field application unit.

18. The sample observation device according to claim 17, wherein the current application unit comprises a pair of electrodes to be connected to a surface of the sample.

19. The sample observation device according to claim 18, wherein the pair of electrodes are made of a non-magnetic metal.

20. The sample observation device according to claim 18, wherein the pair of electrodes are conductive cantilevers for an atomic force microscope.

21. The sample observation device according to claim 20, wherein the pair of electrodes can be positioned independently from each other in a plane parallel to the flat portion of the stage.

22. The sample observation device according to claim 19, wherein a pair of holding members for fixing the sample are arranged on opposite sides of the flat portion of the stage, and the pair of holding members serve as the pair of electrodes.

23. The sample observation device according to claim 16, wherein the device comprises a displacement mechanism for relatively displacing the probe in a plane parallel to the flat portion of the stage.

24. The sample observation device according to claim 16, wherein the device comprises an arithmetic unit for calculating the variation in surface potential due to variation in the Hall effect, using the surface potential measured by the probe as input data.

25. The sample observation device according to claim 24, wherein the arithmetic unit calculates the variation in surface potential due to variation in the Hall effect at a plurality of locations while the probe is being displaced in two directions along a surface of the sample.

26. The sample observation device according to claim 25, wherein the device comprises a monitor unit for displaying the variation in surface potential calculated by the arithmetic unit as a two-dimensional distribution along the surface of the sample.

27. The sample observation device according to claim 23, wherein the probe is a cantilever for a scanning probe microscope.

28. The sample observation device according to claim 27, wherein the scanning probe microscope comprises an element for measuring the surface potential of the sample by Kelvin Probe Force Microscopy.

29. The sample observation device according to claim 28, wherein an AC power source and a DC bias necessary for Kelvin Probe Force Microscopy are connected between the probe and a ground, or between a power source of the current and a ground.

30. The sample observation device according to claim 27, wherein the scanning probe microscope comprises an element for measuring the surface potential of the sample by the Kelvin method.

31. The sample observation device according to claim 17, wherein the magnetic field application unit is constituted of a permanent magnet, and comprises a magnet drive unit for varying a distance between the permanent magnet and the flat portion of the stage.

32. The sample observation device according to claim 17, wherein the magnetic field application device comprises an electric magnet, a Helmholtz coil, or a superconducting magnet.

33. The sample observation device according to claim 16, wherein the stage is supported rotatably in a plane parallel to the flat portion, and coupled to a rotational drive mechanism.
